(19) United States
(12) Patent Application Publication
(10) Pub. No.: US 2005/0032452 A1
(43) Pub. Date: Feb. 10, 2005

(54) Conformable surfacing veil or reinforcement mat

(76) Inventor: Gregory S. Helwig, Granville, OH (US)

Correspondence Address: OWENS CORNING, 2790 COLUMBUS ROAD, GRANVILLE, OH, 43023, US

(21) Appl. No.: 10/636,078

(22) Filed: Aug. 7, 2003

(51) Int. Cl. B32B 3/26; B32B 3/00; B32B 1/00

(52) U.S. Cl. 442/352; 428/313.3; 428/369; 428/373; 442/353; 442/356; 442/357; 442/364; 442/409; 156/166; 162/156; 162/157.1; 162/158; 162/164.1

(57) ABSTRACT

A conformable surfacing veil having an improved soft feel is formed by admixing a thermoplastic sheath-core bicomponent fiber with a regularly or irregularly shaped structural fiber to form a core composition for the mat. The bicomponent fiber is formed from a core material and a sheath material. Suitable core material include thermoplastic polymers such as polyethylene terephthalate that have a higher melting point than the sheath like polymer. Suitable sheath materials include polyethylene, polypropylene, and copolyesters having softening points lower than the core material. Thus, when the mixture of structural fibers and bicomponent fibers is heated above the softening point of the sheath materials, the bicomponent fiber will fuse to the structural fibers. The surfacing veils can then be laminated to other reinforcing mats for use as a reinforcement for plastic articles.

### TECHNICAL FIELD AND INDUSTRIAL APPLICABILITY OF THE INVENTION

The present invention relates generally to fiber-reinforced materials and more specifically to a conformable surfacing veil or reinforcement mat.

### BACKGROUND OF THE INVENTION

Surfacing veils are used extensively in the reinforced plastics industry to provide improved appearance and corrosion resistance. These veils essentially act as sponges that support a resin-rich layer at the surface of the reinforced plastic article. Surfacing veils help prevent print-through of contours of the bundles of reinforcing fibers that lay beneath the surface.

Most commonly used surfacing veils consist of either glass or polyester fibers. Glass surfacing veils are usually produced by either a dry-laid or wet-laid process and typically employ a resin binder to hold the fibers together. Polyester surfacing veils are generally formed using a spun bonded or woven construction process.

Glass surfacing veils are generally less costly than polyester surfacing veils and typically offer better compatibility with a wide variety of resins because the glass fibers have a higher surface energy that allows them to be more easily wet out within the matrix resin.

The principal disadvantage of glass surfacing veils is that they have difficulty conforming to complex shapes. The glass fibers themselves do not elongate significantly under stress and have much higher bending stiffness compared to polyester fibers. Thus, if a glass-surfacing veil is placed in a recessed region with compound curvature, the glass veil will likely form a crease. Further, if glass veils are placed over a protruding region such as a boss, the lack of elongation will likely cause the surfacing veil to tear.

It is therefore highly desirable to introduce a new surfacing veil that combines most of the positive attributes of glass-fiber and polyester-fiber surfacing veils without the associated deficiencies.

It is a further object of the present invention to create plastic articles having the new surfacing veil that offers desired surface appearance and desired reinforcing properties.

### SUMMARY OF THE INVENTION

A conformable surfacing veil having an improved soft feel is formed by admixing a thermoplastic sheath-core bicomponent fiber with a structural fiber to form a core composition for the mat.

The bicomponent fiber is formed from a core material and a sheath material. Suitable core materials include thermoplastic polymers such as polyethylene terephthalate (PET) that have a higher melting point than the sheath material. Suitable sheath materials include polyethylene, polypropylene, and copolyesters having softening points lower than PET. Thus, when the mixture of glass fibers and bicomponent fibers is heated above the softening point of the sheath materials, the bicomponent fiber will fuse to the glass fibers. The non-woven structures produced are tough and stretchy and have a much softer feel than standard glass veils.

In an alternative preferred embodiment, a plurality of crimped fibers, some or all of which may be hollow, can replace a portion of the wet use chop strands in the veil. The crimped fibers increase the loft of the nonwoven structure, providing a thicker reinforcing layer without increasing the weight of the surfacing veil.

In another alternative preferred embodiment, a plurality of spiral or randomly coiled fibers may replace some or all of the wet use chop strands in the veil. Similar to the crimped fibers, these coiled fibers add loft to the veil, therein forming a lighter veil per unit volume without degrading strength characteristics.

In another alternative preferred embodiment, a plurality of polymeric expandable microspheres may be added to the conformable veil. These microspheres expand when heated, and thus provide additional loft to the conformable veil.

The conformable veils of the present invention may be introduced into the reinforced plastic article independently of the primary reinforcements. Alternatively, the conformable veils may be combined with other reinforcing mats or fabrics by stitching or heat laminating.

Other objects and advantages of the present invention will become apparent upon considering the following detailed description and appended claims, and upon reference to the accompanying drawings.

### BRIEF DESCRIPTION OF THE DRAWINGS

FIG. 1 is a perspective view of a conformable surfacing veil according to one preferred embodiment of the present invention;

FIG. 2 is a section view of the bicomponent fiber of FIG. 1 taken along line 2-2;

FIG. 3 is a perspective view of a conformable surfacing veil according to another preferred embodiment of the present invention;

FIG. 4 is a perspective view of a conformable surfacing veil according to another preferred embodiment of the present invention;

FIG. 5 illustrates a wet-processing line for forming the conformable veil of FIG. 1; and

FIG. 6 illustrates a dry-processing line for forming the conformable veil of FIG. 1.

### DETAILED DESCRIPTION AND PREFERRED EMBODIMENTS OF THE INVENTION

The present invention is directed to a improved surfacing veil for use extensively in the reinforced plastics industry. The surfacing veils support the resin-rich surface layer of the reinforced plastic articles to improve surface appearance and improve corrosion resistance. The surfacing veils of the present invention can be produced using either a wet-laid or dry-laid process and is described below.

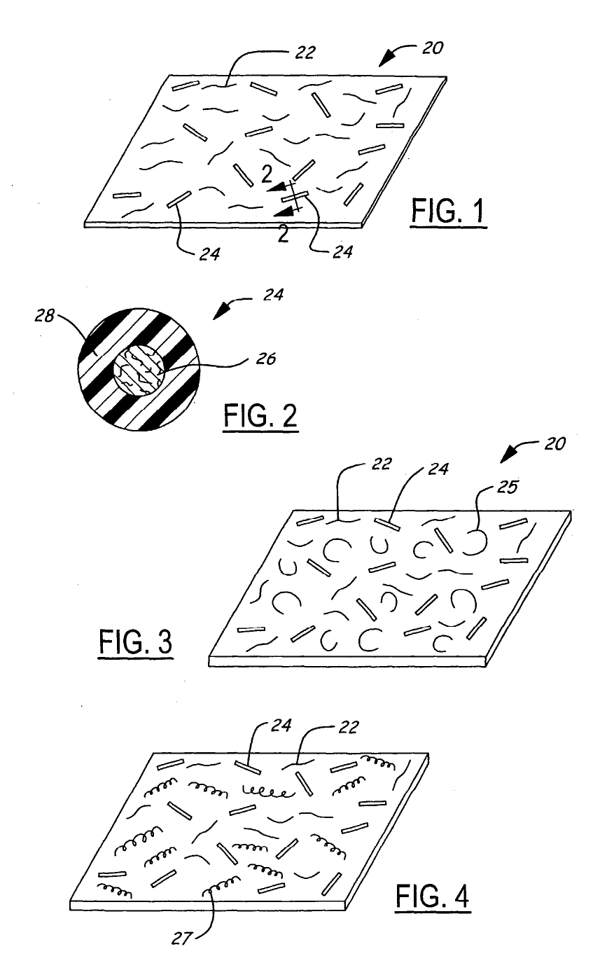

Referring now to FIG. 1, a perspective view of the conformable surfacing veil 20 in one preferred embodiment is shown having a plurality of structural fibers 22 coupled to a plurality of bicomponent synthetic fibers 24. The bicomponent synthetic fibers 24 have a core 26 substantially surrounded by an outer polymer annulus, or sheath 28.

As best shown in FIG. 2, the bicomponent synthetic fibers 24 include a core 26 of polyethylene terephthalate (PET). The core 26 exhibits a melting/bonding temperature of, for example, 485 degrees Fahrenheit (252 degrees Celsius) and constitutes approximately 60 percent of the fiber 24 on a cross sectional and weight basis. The core 26 is fully surrounded by an annulus or sheath 28 of a low melt temperature copolymer polyester, polyethylene or polypropylene. The sheath 28 exhibits a melting/bonding temperature of, for example, 285 degrees Fahrenheit (138 degrees Celsius) or, in any event, a temperature significantly lower, that is, at least about 100 degrees Fahrenheit lower than the melting/bonding temperature of the core 26. The sheath 28 comprises approximately 40 percent of the cross section and thus weight of the bi-component fibers 24. A suitable product for use as the bi-component fibers 24 are polyethylene sheath/polyester core fibers manufactured and sold by KoSa as Type 105 Celbond® Bicomponent Fiber. Other suitable fibers are copolyester sheath/polyester core fibers, such as Type 104 or Type J58 Celbond Bicomponent Fiber.

The bi-component fibers 24 have linear densities in the range of about 1 to 10 denier (corresponding to a fiber diameter of approximately 10 to 35 microns) and more preferably about 2 to 4 denier (approximately 15 to 20 microns). Length of the bi-component fibers 24 may range from less than about 0.25 inch to 3 inches and longer.

It should be understood that the melting/bonding temperatures recited directly above will be inherent features of the particular sheath and core polymers chosen. Accordingly, they may vary greatly from the temperatures given. What is important is that there be a significant difference between the melting point of the core 26 and the melting temperature of the sheath 28 and furthermore that the melting temperature of the sheath 28 be the lower of the two values. So configured, the sheath 28 will melt/bond at a lower temperature than the core 26, the features and benefits thereof within the context of the present invention being more fully described subsequently.

The structural fibers 22 preferably consist of high strength fibrous materials compatible with the plastics within which they are used. Two preferred structural fibers include glass fibers and polyester fibers. One preferred structural fiber 22 consists of Owens Corning's Advantex® glass fibers in the form of wet-used chopped strands. However, other preferred glass fibers that may be utilized include other E-type glass filaments, S-type glass filaments, alkaline resistant glass filaments, C-glass filaments or ECR-type glass filaments. Preferably, the glass fibers will have a diameter of 6 to 25 microns, and more preferably 10 to 23 microns. The length of the fibers may vary from less than 0.125 inch to more than 3 inches.

Preferred polyester fibers include straight, round, cut staple filaments of poly(ethylene terephthalate) such as Type 100 polyester staple manufactured and sold by KoSa. Other preferred polyester fibers include staple fibers with hollow, trilobal, or pentalobal cross-sections. These preferred fibers may have a linear density of less than 0.5 denier to more than 15 denier, and more preferably 1.5 denier to 6 denier. The length of the fibers may vary from less than 0.25 inch to more than 3 inches.

Other preferred structural fibers include carbon fibers and metal fibers. These fibers are electrically conductive and when introduced near the surface of a plastic article as part of the surfacing veil will increase the surface conductivity of the part. An electrically conductive surface facilitates the painting of the plastic article by electrostatic techniques.

In alternative preferred embodiments, as shown in FIGS. 3 and 4, a plurality of irregularly shaped fibers may replace a portion of the structural fibers 22 within the veil 20. The irregular fibers may be crimped fibers (shown in FIG. 3 as 25) or randomly coiled or spiral type fibers (shown in FIG. 4 as 27). Similar to the structural fibers 22 they replace, these irregular fibers have a melting point at least 100 degrees Fahrenheit greater than the sheath 28.

As shown in FIG. 3, these crimped fibers 25 increase the thickness of the veil 20, thus providing for a thicker resin-rich layer at the surface of the composite. These crimped fibers 25 are preferably polymer fibers such as polyester or nylon crimped fibers. A preferred crimped polyester fiber 25 is Type 205 polyester staple manufactured and sold by KoSa. These crimped fibers 25 preferably have a linear density from 1.5 to 15 denier, and more preferably from 3 to 6 denier. These fibers 25 may be hollow for additional loft and recovery.

As shown in FIG. 4, these coiled or spiral type fibers 27 provide added loft and recovery to the formed core 26 without an increase in weight. Preferred coiled or spiral type fibers 27 that may be used include irregularly shaped glass fibers such as those disclosed in U.S. Pat. No. 5,431,992 which is herein incorporated by reference. Other types of randomly coiled or spiral type fibers that may be used includes other glass fibers, polymeric, bicomponent polymeric fibers, or other randomly coiled or spiral type fibers known to those of ordinary skill in the art.

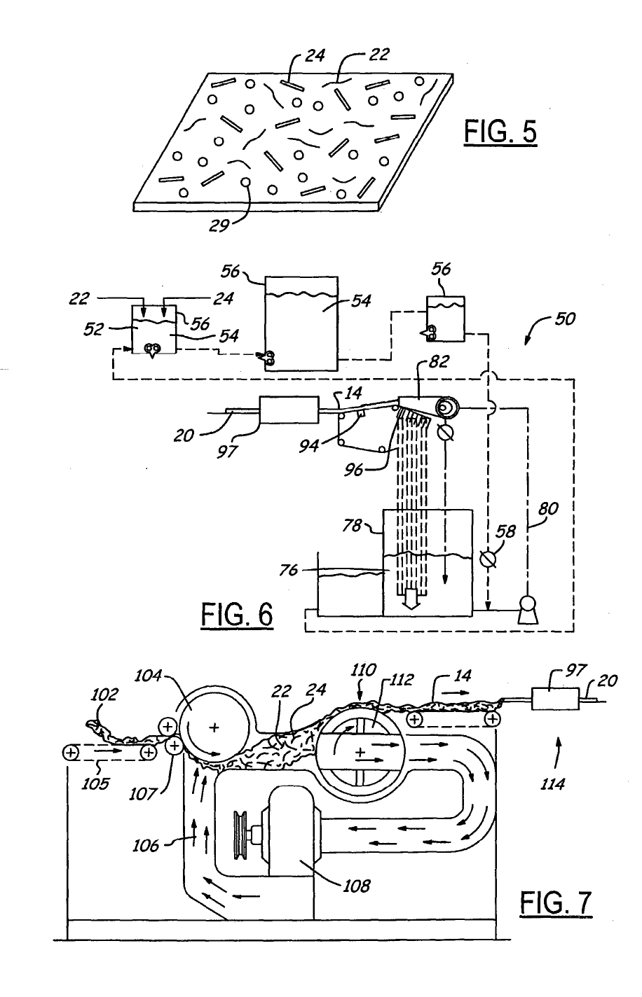

In another alternative preferred embodiment, as shown in FIG. 5, a plurality of polymeric expandable microspheres 29 may be introduced during the manufacturing of the veil 20. The microspheres 29 comprise about 5 to 20 percent of the total weight of the veil 20. The microspheres 29 expand when heated within the veil 20, therein providing decreased density per square unit area. This forms veils 20 exhibiting increased loftiness. The microspheres 29 typically would be introduced into the already formed veil by saturating the dry veil with an aqueous slurry of the microspheres 29, drying the saturated veil and heating the combination of fibers and microspheres to the expansion temperature of the microspheres 29. Preferred expandable microspheres 29 include Micropearl™ plastic microcapsules sold by Sovereign Specialty Chemicals.

FIG. 6 illustrates a processing line 50 used for forming the conformable veil 20 of FIG. 1. A 95-25/5-75 by weight percentage combination of the structural fibers 22 and the bi-component fibers 24 are added to a whitewater chemical dispersion 52 within a whitewater tank 56 to form a thick whitewater slurry 54 at consistency levels of approximately 0.2 to 1 percent. The thick slurry 54 formed is maintained under agitation in a single tank 56 or series of tanks.

While not shown if FIG. 6, the crimped fibers 25 of FIG. 3, or the spiral type fibers 27 of FIG. 4, may replace a portion of the structural fibers 22 in the whitewater chemical dispersion 52 with whitewater tank 56.

The whitewater chemical dispersion 52 is used to obtain reasonable filamentation of structural fibers 22 and the bicomponent fibers 24 through steric, thermodynamic, and charge colloidal interactions. The preferred whitewater dispersion 52 includes a viscosity modifier, a defoamer and a surfactant.

The viscosity modifiers used in the whitewater dispersion 52 are commonly used in nonwoven-type applications. One preferred class of viscosity modifiers is a polyacrylamide viscosity modifier such as Nalco 7768, Magnifloc 1886A, and HyChem AE 874. Another preferred viscosity modifier is a hydroxyethylcellulose, such as Natrosol 250HHBR. However, other possible viscosity modifiers or flocculants that may be used include high molecular weight, water-soluble polymers that are well known to those of ordinary skill in the art.

The surfactants, or cationic dispersants, used in the whitewater dispersion 52 aid in the wetting of the structural fibers 22 and bicomponent fibers 24 so that bundles of the fibers 22, 24 will disperse into individual filaments. One class of surfactants utilized are ethoxylated alkylamine dispersants such as Schercopol DS-140, Nalco 8493, or Rhodameen VP532. However, other dispersants may be used as well, including fatty acid amine oxides and polyethoxylated derivatives of amide condensation of fatty acid products.

Also, preferred defoamers utilized in the whitewater dispersion 52 include Nalco PP04-3840 and GEO FM LTX.

The thick slurry 54 is then delivered through a control valve 58 and combined with a whitewater stream 76 from a silo 78 to form a lower consistency slurry 80 in the former 82. The ratio of thick slurry 54 to the silo stream 78 in the lower consistency slurry 80 will typically be in the range of 1:10 and 1:40.

The former 82, or headbox, functions to equally distribute and randomly align the fibers 22, 24 onto a moving woven fabric, or forming wire 96, therein forming the filament network 14. Formers 82 that can accommodate the initial fiber formation include Fourdrinier machines, Stevens Former, Roto Former, Inver Former, cylinder, and VertiFormer machines. These formers offer several control mechanisms to control fiber orientation within the network 14 such as drop leg and various pond regulator/wall adjustments.

Deposited fibers forming the network 14 are partially dried over a suction box 94. The dewatered network 14 is then run through a drying oven 97 at a temperature sufficient to remove any excess water and sufficient to melt the sheath 28 without melting the core 26 of the bicomponent fiber, typically about 150-200 degrees Celsius. Upon removal from the oven 97, the sheath 28 material cools and adheres to both the core 26 and to the structural fibers 22, therein forming a conformable surfacing veil 20. The conformable veil 20 formed herein produces a tough, stretchy product with a much softer feel than standard glass surfacing veils.

While a wet laid process as described above is one preferred process for forming the conformable veil 20 because of its greater weight uniformity and fast production rate (up to about 1200 feet per minute), a wet laid process is best suited for use with shorter fibers to form light, thin nonwoven mats.

To form heavier mats having a basis weight of greater than 300 grams per square meter, a dry laid process is preferred. Dry laid processes can be used to create loftier veils (and mats) formed from longer fibers, but utilize slower line speeds (about 50-200 feet per minute maximum). One preferred dry-laid process, as shown in FIG. 5 below, for forming the conformable veil is achieved using aerodynamic web formation, wherein fibers are captured onto a forming screen from an air-stream using a Rando-Webber component machine 100.

Referring now to FIG. 7, plied cards webs 102 (or lap card webs) are pre-opened onto a feed table 105, therein forming fibers 22, 24. These fibers 22, 24 are fed through a draw-in cylinder 207 into a spiked roller 104, which separates the fibers 22, 24 into an airstream 106 created by a ventilator 108. The web 102 is then delivered to a conveyor 110 having a perforated cylinder 112 for transporting to a bonding area 114. Air drawn through the perforated cylinder 112 is used to allow the fibers 22, 24 to lay down on the conveyor 110 as a random filament network 14 similar to the random filament network of FIG. 6.

While not shown, the bonding area 114 processes the filament network 14 in a manner similar to oven 97 in FIG. 4 above. Thus, the bonding area 114 melts the sheath 28 without melting the core 26 of the bicomponent fiber 24 at a temperature typically between about 150 and 200 degrees Celsius. Upon removal from the bonding area 114, the sheath 28 material cools and adheres to both the core 26 and to the structural fibers 22, therein forming a conformable surfacing veil 20.

One feature of the conformable veil 20 is that upon reheating of the veil 20, the sheath 28 of the bicomponent fiber 24 will again soften. This allows the conformable veil 20 to be thermally laminated to other materials. For example, stitched multilayer or multi-axial fabrics are commonly used as a reinforcement in plastic articles, such as boat hulls, manufactured by a vacuum infusion process. Generally, surfacing veils cannot be stitched to the reinforcing fabric because the depressions created by the stitch would print-through to the surface of the part. By laying the conformable veil 20 onto a reinforcing fabric and applying heat and light pressure, the veil 20 will bond to the fabric to yield a single structure. This avoids the need to lay the surfacing veil into the mold separately from the reinforcing fabric, reducing the chance for the formation of wrinkles or voids in the molded part.

### EXAMPLE 1

In a preferred embodiment, a veil with a basis weight of 50 g/m² was prepared on wet process machine by mixing 540 pounds of 13 micron×18 mm Owens Corning 9501 wet chop glass fibers and 220 pounds of 3.3 dtex×12 mm KoSa Type 105 bicomponent fibers in 20000 gallons of whitewater. The slurry was mixed with vigorous agitation for approximately 10 minutes and was then transferred to the machine chest. A 1000 gallon per minute stream of this thick stock slurry was delivered into a 20000-gallon per minute white water flow and the resulting thin stock was delivered to the headbox of a Sandy Hill inclined-wire Fourdrinier machine, operating at a line speed of 350 feet per minute. The dewatered sheet is then run through a drying oven at 170 degrees Celsius without the addition of any other binder, thereby producing a tough, stretchy product with a must softer feel than standard glass veils.

### EXAMPLE 2

In another preferred embodiment, veil with a basis weight of 200 g/m² was prepared on the same machine as in Example 1 by mixing 1625 pounds of Owens Corning 9501 glass fibers (23 micron×37 mm) and 160 pounds of KoSa Type 105 bicomponent fibers (3.3 dtex×12 mm) in 20,000 gallons of whitewater. In a manner similar to Example 1, this thick stock slurry was used to form a nonwoven web at a line speed of 250 feet per minute. This mat was dewatered and dried at a temperature of 170 degrees Celsius. The mat formed here is much more flexible and has a much softer feel than Owens Corning VL8101 reinforcement mat, which is comprised of the same glass fibers but bonded with an amount of thermosetting acrylic binder, equivalent to the amount of bicomponent fiber in the present example.

Potential applications for the conformable veil 20 formed in accordance with the present invention include a surfacing veil for the molding of reinforced plastic articles with compound curvature such as cafeteria trays; a surfacing veil for the pultrusion of thin-walled parts with complex shapes such as window lineals; a surfacing veil that can be thermally laminated to a multi-axial reinforcing fabric used in vacuum-infusion molding of boat hulls and rotor blades of wind energy turbines; and as the core of a multi-axial reinforcing fabric for vacuum infusion molding where the use of crimped fibers for loft and recovery will provide an enhanced flow medium for the infused resin.

Prior to its incorporation into the reinforced plastic articles, the conformable veil 20 may also be printed with designs, logos, or text. These designs may be directly printed onto the veil by a technique such as offset lithography or by transfer printing using a technique such as dye-sublimation. When incorporated into a reinforced plastic article using a clear or translucent matrix resin or a clear gel coat, a printed conformable surfacing veil allows the introduction of a design, logo, or text that is integral to the article and eliminates the need to apply such designs by painting or affixing a label to the article.

While the invention has been described in terms of preferred embodiments, it will be understood, of course, that the invention is not limited thereto since modifications may be made by those skilled in the art, particularly in light of the foregoing teachings.

1. A conformable surfacing veil comprising:
a plurality of structural fibers; and
a plurality of bicomponent fibers coupled to said plurality of structural fibers, each of said plurality of bicomponent fibers having a core substantially surrounded by an outer polymer annulus, wherein the melting point of said outer polymer annulus is significantly lower than said core and said plurality of structural fibers.

2. The conformable surfacing veil of claim 1, wherein a portion of said plurality of structural fibers comprises one or more irregularly shaped fibers, said one or more irregularly shaped fibers having a melting point significantly higher than said outer polymer annulus.

3. The conformable surfacing veil of claim 2, wherein said plurality of irregularly shaped fibers have a linear density of between about 1.5 and 15 denier.

4. The conformable surfacing veil of claim 2, wherein said one or more irregularly shaped fibers comprises one or more crimped fibers.

5. The conformable surfacing veil of claim 2, wherein said one or more irregularly shaped fibers comprises one or more crimped polyester fibers.

6. The conformable surfacing veil of claim 2, wherein said one or more irregularly shaped fibers comprises one or more crimped nylon fibers.

7. The conformable surfacing veil of claim 2, wherein said one or more irregularly shaped fibers comprises one or more randomly coiled or spiral fibers.

8. The conformable surfacing veil of claim 1 further comprising a plurality of microspheres, said plurality of microspheres comprising between about 5 and 20 weight percent of the conformable surfacing veil.

9. The conformable surfacing veil of claim 1, wherein said plurality of structural fibers comprises a plurality of glass fibers, said glass fibers selected from the group consisting of E-type glass filaments, S-type glass filaments, alkaline resistant glass filaments, C-glass filaments, ECR-type glass filaments, wet use chop strands, and combinations thereof.

10. The conformable surfacing veil of claim 9, wherein said plurality of glass fibers have a diameter between approximately 6 and 25 microns and a length of between about 0.125 inches and 3 inches.

11. The conformable surfacing veil of claim 1, wherein said plurality of structural fibers comprises a plurality of polyester fibers.

12. The conformable surfacing veil of claim 11, wherein said plurality of polyester fibers have a linear density of between approximately 0.5 and 15 denier and a length of between about 0.125 inches and 3 inches.

13. The conformable surfacing veil of claim 11, wherein said plurality of polyester fibers is selected from the group consisting of straight filaments of polyethylene terephthalate fibers, round filaments of polyethylene terephthalate fibers, and cut staple filaments of polyethylene terephthalate fibers.

14. The conformable surfacing veil of claim 1, wherein said plurality of structural fibers comprise between approximately 25 and 95 percent of the total weight of the conformable surfacing veil.

15. The conformable surfacing veil of claim 1, wherein said core comprises polyethylene terephthalate.

16. The conformable surfacing veil of claim 1, wherein said core comprises approximately 60 weight percent of said bicomponent fiber.

17. The conformable surfacing veil of claim 1, wherein said outer polymer annulus comprises a low melt copolymer polyester.

18. The conformable surfacing veil of claim 1, wherein said outer polymer annulus comprises a low melt copolymer polyethylene.

19. The conformable surfacing veil of claim 1, wherein said outer polymer annulus comprises a low melt copolymer polypropylene.

20. The conformable surfacing veil of claim 1, wherein the melting point of said outer polymer annulus is at least 100 degrees Fahrenheit lower than the melting point of said core and said plurality of structural fibers.

21. The conformable surfacing veil of claim 1, wherein said plurality of structural fibers comprises a plurality of glass fibers, said glass fibers selected from the group consisting of E-type glass filaments, S-type glass filaments, alkaline resistant glass filaments, C-glass filaments, ECR-type glass filaments, wet use chop strands, and combinations thereof; and
wherein said outer polymer annulus comprises a low melt copolymer polyester.

22. The conformable surfacing veil of claim 1, wherein said plurality of structural fibers comprises a plurality of glass fibers, said glass fibers selected from the group consisting of E-type glass filaments, S-type glass filaments, alkaline resistant glass filaments, C-glass filaments, ECR-type glass filaments, wet use chop strands, and combinations thereof; and
wherein said outer polymer annulus comprises a low melt copolymer polyethylene.

23. The conformable surfacing veil of claim 1, wherein said plurality of structural fibers comprises a plurality of glass fibers, said glass fibers selected from the group consisting of E-type glass filaments, S-type glass filaments, alkaline resistant glass filaments, C-glass filaments, ECR-type glass filaments, wet use chop strands, and combinations thereof; and
wherein said outer polymer annulus comprises a low melt copolymer polypropylene.

24. A reinforced plastic article having a conformable surfacing veil as in claim 1.

25. The reinforced plastic article of claim 24, wherein the reinforced plastic article has a compound curvature within a portion containing said conformable surfacing veil.

26. A method for forming a conformable surfacing veil using a wet laid process comprising:
introducing a plurality of structural fibers and a plurality of bicomponent fibers to a whitewater chemical dispersion to form a whitewater slurry, said plurality of structural fibers comprising between about 25 and 95 weight percent of the total weight of said plurality of structural fibers and said plurality of bicomponent fibers, each of said plurality of bicomponent fibers having a core substantially surrounded by an outer polymer annulus, wherein the melting point of said outer polymer annulus is significantly lower than said core and said plurality of structural fibers;
forming a filament network from said whitewater slurry;
introducing said filament network to an oven at a first temperature to melt said outer polymer annulus, said first temperature being less than the melting point of said core and said plurality of structural fibers;
removing said filament network from said oven, wherein said outer polymer annulus cools and adheres said bicomponent fibers to said plurality of structural fibers.

27. The method of claim 26, wherein forming a filament network from said whitewater slurry comprises:
reducing the viscosity of said whitewater slurry by introducing a whitewater stream to said whitewater slurry to form a lower consistency slurry;
introducing said lower consistency slurry to a former, said former functioning to align and distribute said plurality of structural fibers and said plurality of bicomponent fibers onto a moving woven fabric to form a random filament network; and
partially drying said random filament network over a suction box.

28. The method of claim 26, wherein the ratio of said whitewater slurry to said whitewater stream in said lower consistency slurry is between approximately 1:10 and about 1:40 by weight.

29. The method of claim 26, wherein said first temperature is between approximately 150 and 200 degrees Celsius.

30. A method for forming a conformable surfacing veil using a dry-laid process comprising:
introducing one or more plied card webs to a spiked roller to separate said plied card webs into a plurality of structural fibers and a plurality of bicomponent fibers, each of said plurality of bicomponent fibers having a core substantially surrounded by an outer polymer annulus, wherein the melting point of said outer polymer annulus is significantly lower than said core and said plurality of structural fibers;
introducing said plurality of structural fibers and said plurality of bicomponent fibers into an airstream created by a ventilator;
delivering said plurality of structural fibers and said plurality of bicomponent fibers to a conveyor having a perforated cylinder, wherein said perforated cylinder lays down said plurality of structural fiber and said plurality of bicomponent fibers onto said conveyor to form a random filament network;
introducing said filament network to an oven at a first temperature to melt said outer polymer annulus, said first temperature being less than the melting point of said core and said plurality of structural fibers;
removing said filament network from said oven, wherein said outer polymer annulus cools and adheres said bicomponent fibers to said plurality of structural fibers.

31. The method of claim 30, wherein said first temperature is between approximately 150 and 200 degrees Celsius.

32. A method of forming a reinforcement material for plastic articles, the method comprising:
providing a reinforcing fabric;
forming a conformable surfacing veil, said conformable surfacing veil comprising a plurality of structural fibers coupled to a plurality of bicomponent fibers, each of said plurality of bicomponent fibers having a core substantially surrounded by an outer polymer annulus, wherein the melting point of said outer polymer annulus is significantly lower than said core and said plurality of structural fibers;
laying said conformable surfacing veil onto said reinforcing fabric;
applying light heat and pressure sufficient to remelt said outer polymer annulus; and
cooling said outer polymer annulus such that said outer polymer annulus couples together said reinforcing fabric to said conformable surfacing veil.

33. The method of claim 32, wherein forming a conformable surfacing veil comprises forming said conformable surfacing veil using a wet-laid process.

34. The method of claim 33, wherein forming said conforming surfacing veil using a wet-laid process comprises:
introducing a plurality of structural fibers and a plurality of bicomponent fibers to a whitewater chemical dispersion to form a whitewater slurry, said plurality of structural fibers comprising between about 25 and 95 weight percent of the total weight of said plurality of structural fibers and said plurality of bicomponent fibers, each of said plurality of bicomponent fibers having a core substantially surrounded by an outer polymer annulus, wherein the melting point of said outer polymer annulus is significantly lower than said core and said plurality of structural fibers;
forming a filament network from said whitewater slurry;
introducing said filament network to an oven at a first temperature to melt said outer polymer annulus, said first temperature being less than the melting point of said core and said plurality of structural fibers;
removing said filament network from said oven, wherein said outer polymer annulus cools and adheres said bicomponent fibers to said plurality of structural fibers.

35. The method of claim 32, wherein forming a conformable surfacing veil comprises forming said conformable surfacing veil using a dry-laid process.

36. The method of claim 35, wherein forming said conforming surfacing veil using a dry-laid process comprises:
introducing one or more plied card webs to a spiked roller to separate said plied card webs into a plurality of structural fibers and a plurality of bicomponent fibers, each of said plurality of bicomponent fibers having a core substantially surrounded by an outer polymer annulus, wherein the melting point of said outer polymer annulus is significantly lower than said core and said plurality of structural fibers;
introducing said plurality of structural fibers and said plurality of bicomponent fibers into an airstream created by a ventilator;
delivering said plurality of structural fibers and said plurality of bicomponent fibers to a conveyor having a perforated cylinder, wherein said perforated cylinder lays down said plurality of structural fiber and said plurality of bicomponent fibers onto said conveyor to form a random filament network;
introducing said filament network to an oven at a first temperature to melt said outer polymer annulus, said first temperature being less than the melting point of said core and said plurality of structural fibers;
removing said filament network from said oven, wherein said outer polymer annulus cools and adheres said bicomponent fibers to said plurality of structural fibers.
